(19) United States
(12) Patent Application Publication
(10) Pub. No.: US 2004/0208247 A1
(43) Pub. Date: Oct. 21, 2004

(54) Method and device for generating a scalable coded video signal from a non-scalable coded video signal

(76) Inventors: Eric Barrau, Puteaux (FR); Anthony Morel, Xi'An (CN)

Correspondence Address: U S Philips Corporation, Intellectual Property Department, PO Box 3001, Briarcliff Manor, NY, 10510, US

(21) Appl. No.: 10/482,883

(22) PCT Filed: Jul. 5, 2002
(86) PCT No.: PCT/IB02/02819

(30) Foreign Application Priority Data
Jul. 10, 2001 (EP) 01401850.1

(51) Int. Cl. H04N 7/12

(52) U.S. Cl. 375/240.27; 375/240.23; 375/240.12

(57) ABSTRACT

The invention relates to a method of modifying data in an input coded video signal for generating an output scalable video signal composed of a base video signal and a set of at least one enhancement video signal, said method comprising at least an error decoding step for generating a decoded data signal from said input coded video signal, a first re-encoding step for generating said base video signal from an intermediate data signal resulting from the addition of a motion-compensated signal to said decoded data signal, a reconstruction step for generating a coding error of said base video signal, a motion compensation step for generating said motion-compensated signal from said coding error, a second re-encoding step for generating said enhancement video signal from said coding error. The coding error of said base video signal is re-encoded with a finer granularity than the one used for generating said base video signal.

### FIELD OF THE INVENTION

The present invention relates to a first method of modifying data in an input coded video signal, for generating an output scalable video signal composed of a base video signal and a set of at least one enhancement video signal, said method comprising at least:

an error decoding step for generating a decoded data signal from said input coded video signal,

a first re-encoding step for generating said base video signal from an intermediate data signal resulting from the addition of a motion-compensated signal with said decoded data signal,

a reconstruction step for generating a coding error of said base video signal,

a motion compensation step for generating said motion-compensated signal from said coding error.

The present invention also relates to a second method of modifying data in an input coded video signal, for generating an output scalable video signal composed of a base video signal and a set of at least one enhancement video signal, said method comprising at least:

an error decoding step for generating a decoded data signal from said input coded video signal,

a first re-encoding step for generating said base video signal from said decoded data signal,

a reconstruction step for generating a coding error of said base video signal.

The invention also relates to a transcoding device for carrying out the first or the second method. This invention may be used, for instance, in the field of video broadcasting or video storage.

### BACKGROUND OF THE INVENTION

With the emergence of new information technologies, compressed video is used in various applications, e.g. in professional applications and/or consumer products, which implies that the bitrate of transmitted coded video signal must be adapted to the bandwidth capacity of communication networks. To this end, transcoding methods are used to achieve said data manipulation.

A transcoding method has been proposed in European patent application EP 0 690 392 A1. This method is used for performing a bitrate reduction of an input video signal coded in accordance with the MPEG-2 standard. This patent application describes a method and its corresponding device for modifying an input coded video signal, for generating from an input coded video signal, a scalable video signal composed of a set of coded video signals having different quality levels.

The scalable video signal generated by the prior art method is composed of a base video signal of a low quality and an enhancement video signal carrying video information of a higher quality. The enhancement video signal is generated by a re-encoding step inserted in series in the motion compensation loop, i.e. acting on the coding error of said base video signal. This re-encoding step also generates a modified coding error used as a video signal in the motion compensation step. This re-encoding step comprises a quantization step applied to said coding error, followed by a variable-length encoding step generating said enhancement video signal. In parallel, the output signal of said quantization step is inverse-quantized for generating an inverse quantized signal from which said coding error is subtracted, resulting in said modified coding error. It is also describes that other quality levels can be obtained in repeating a similar re-encoding step in cascade.

However, the method of modifying data according to the prior art is subject to limitations.

First, the re-encoding step as described in the prior art necessitates quantization and inverse quantization steps. Since these processing steps are very consuming in terms of computational resources, such a method is limited to an implementation in professional products, not in consumer products. This limitation is justified in so far that this prior-art method generates a plurality of video signals having different qualities since, in this case, one must envisage as many quantization and inverse quantization steps as video signals having a different quality.

Secondly, according to the setting of said re-encoding step, the amplitude of the modified coding error may change in large proportions if the quality level of an enhancement video signal is decreased. Indeed, the fact that the coding error is modified by said re-encoding step before being motion-compensated may perturb the bitrate regulation of said base video signal, leading to difficulties for keeping a targeted bitrate of said base video signal.

Finally, the content of the base video signal generated according to the prior-art method is dependent on the re-encoding step generating the enhancement video signal, since said base video signal is generated from at least said modified coding error after motion compensation. As a consequence, if said enhancement video signal is lost during the joint transmission with the base video signal, the decoding of said base video signal will introduce quality drift because reference frames used during encoding cannot be reconstructed at the decoding side.

### OBJECT AND SUMMARY OF THE INVENTION

It is an object of the invention to solve the limitations of the prior-art method in providing a first and second cost-effective method of modifying an input coded video signal for generating an output scalable video signal composed of a base video signal and a set of enhancement video signals.

To this end, the first method of modifying data according to the invention is characterized in that said first method comprises a second re-encoding step for generating said enhancement video signal from said coding error.

The processing of said input coded video signal results in a scalable video signal. Indeed, while generating a base video signal at a given bitrate from an input coded video signal, this first method allows simultaneous generation of at least one enhancement video signal. The coding error of said base video signal is re-encoded with a finer granularity (i.e. containing finer video data information) than the one used for generating said base video signal. The input coded video signal is thus decomposed after processing in accordance with a plurality of coded video signals: a base video signal corresponding preferably to a low quality version of said input coded video signal, and a set of at least one enhancement video signal, for improving the quality of said base video signal.

The re-encoding step is directly performed on said coding error, which means that the coding error used in the motion compensation step is not modified, avoiding as a consequence encoding disruptions on said base video signal.

Moreover, and contrary to the prior art, in case during a transmission one or a plurality of enhancement video signals are lost, the decoding of the base video signal is not affected (i.e. absence of quality drift) because the reference frames used for such a decoding are totally independent of the enhancement layers.

The second method of modifying data according to the invention is characterized in that said second method comprises a second re-encoding step for generating said enhancement video signal from said coding error.

Compared to the first method previously above according to the invention, the coding loop including the motion compensation step is opened. As a consequence, no more motion compensation step is performed, which allows a reduction of the computational load required by this second method when implemented.

The re-encoding of the coding error resulting in the generation of enhancement video signals compensates the quality drift of the base video signal since the coding error can be partially or totally transmitted simultaneously with said base video signal.

In a preferred mode, each first and second method of modifying data according to the invention is characterized in that said second re-encoding step comprises:

a shifting sub-step for shifting bit-planes of data composing said coding error,

a sub-step for finding the maximum value among data composing said shifted bit-planes, and deriving the number of shifted bit-planes to be re-encoded,

a variable-length coding sub-step of said shifted bit-planes for generating variable-length coded bit-planes, each variable length coded bit-plane defining an enhancement video signal.

These sequential sub-steps allow generation from said coding error of a single enhancement video signal that can easily be degraded and scaled in selecting bit-planes, e.g. the most significant bit-planes. The bitrate of said enhancement video signal can be changed at any location in the binary stream, which allows instantaneous adaptation to bandwidth constraints of the communication channel where video data are sent. It leads to a cost-effective solution since it implies cost-effective sub-steps for which low computational resources are required, and because the re-encoding step directly acts on said coding error in the frequential domain.

The invention also relates to a first video transcoding device for modifying data in an input coded video signal, for generating an output scalable video signal composed of a base video signal and a set of at least one enhancement video signal, said transcoding device comprising at least:

error decoding means for generating a decoded data signal from said input coded video signal,

first re-encoding means for generating said base video signal from an intermediate data signal resulting from the addition of a motion compensated signal with said decoded data signal,

reconstruction means for generating a coding error of said base video signal,

motion compensation means for generating said motion compensated signal from said coding error.

This first transcoding device is characterized in that it comprises second re-encoding means for generating said enhancement video signal from said coding error.

This video transcoding device comprising software and hardware means for implementing the different steps and sub-steps of the first method according to the invention.

The invention also relates to a second video transcoding device for modifying data in an input coded video signal, for generating an output scalable video signal composed of a base video signal and a set of at least one enhancement video signal, said transcoding device comprising at least:

error decoding means for generating a decoded data signal from said input coded video signal,

first re-encoding means for generating said base video signal from said decoded data signal,

reconstruction means for generating a coding error of said base video signal.

This transcoding device is characterized in that it comprises second re-encoding means for generating said enhancement video signal from said coding error.

This video transcoding device comprising software and hardware means for implementing the different steps and sub-steps of the second method according to the invention.

In a particular mode of implementation according to the invention, the first transcoding device and the second transcoding device are such that said second re-encoding means comprises:

shifting means for shifting bit-planes of data composing said coding error,

means for finding the maximum value among data composing said shifted bit-planes, and deriving the number of shifted bit-planes to be re-encoded,

variable length coding means of said shifted bit-planes for generating variable length coded bit-planes, each variable length coded bit-plane defining an enhancement video signal.

The invention also relates to a set-top box product for receiving an input coded video signal, said set-top box product comprising a transcoding device as previously described according to the invention for modifying data in said input coded video signal, for generating an output scalable video signal composed of a base video signal and a set of at least one enhancement video signal.

The invention also relates to a coded video signal comprising a base video signal and a set of at least one enhancement video signal, said coded video signal resulting from an implementation of the first or second method of modifying data in an input coded video signal.

This scalable signal reflects the technical characteristics of steps and sub-steps of the first or second method according to the invention.

The invention also relates to a storage medium having stored thereon a coded video signal, said coded video signal comprising a base layer and a set of enhancement layers, said coded video signal resulting from an implementation of the first or second method of modifying data in an input coded video signal.

The storage medium may preferably correspond to a hard disk or to an erasable digital video disk (e.g. R/W disc).

The invention also relates to a computer program comprising code instructions for implementing the steps and sub-steps of the first or the second method according to the invention.

This computer program comprises a set of instructions which, when loaded into hardware means such as a memory connected to a signal processor, allows to carry out any steps and sub-steps of the first and second method according to the invention previously described.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 depicts a first embodiment of the method according to the invention,

FIG. 2 depicts a second embodiment of the method according to the invention,

FIG. 3 depicts an embodiment of the method allowing the decoding of video signals generated by the method according to the invention.

### DETAILED DESCRIPTION OF THE INVENTION

This invention is well adapted to the data modification of MPEG-2 input coded video signals, but it will be apparent to a person skilled in the art that such a method is applicable to any coded signal that has been encoded with a block-based compression method such as, for example, the one described in MPEG-4, H.261 or H.263 video standards.

The invention will hereinafter be described in detail, assuming that the input coded video signal to be modified complies with the MPEG-2 international video standard (Moving Pictures Experts Group, ISO/IEC 13818-2). It is assumed that a video frame is divided into adjacent squared areas of 16*16 pixels, called macroblocks (MB).

The method according to the invention allows the data modification of an input coded video signal for generating simultaneously a base video signal compliant with the MPEG-2 coding syntax and a set of enhancement video signals. To this end, the base video signal is generated thanks to a transcoding step. This transcoding step consists of reducing the bitrate of said input coded video signal, thus decreasing the video quality as compared with said input coded video signal. The method according to the invention takes advantage of this quality loss for generating said enhancement video signals. The coding error, materializing said quality loss, is re-encoded by the re-encoding step generating said enhancement video signals. The coding error is re-encoded for generating one or a plurality of enhancement video signals comprising supplemental finer video data information not comprised in said base video signal. Thus, the recombination of the base video signal with the enhancement video signals allows to form a video signal of better quality compared to the video quality of the base video signal.

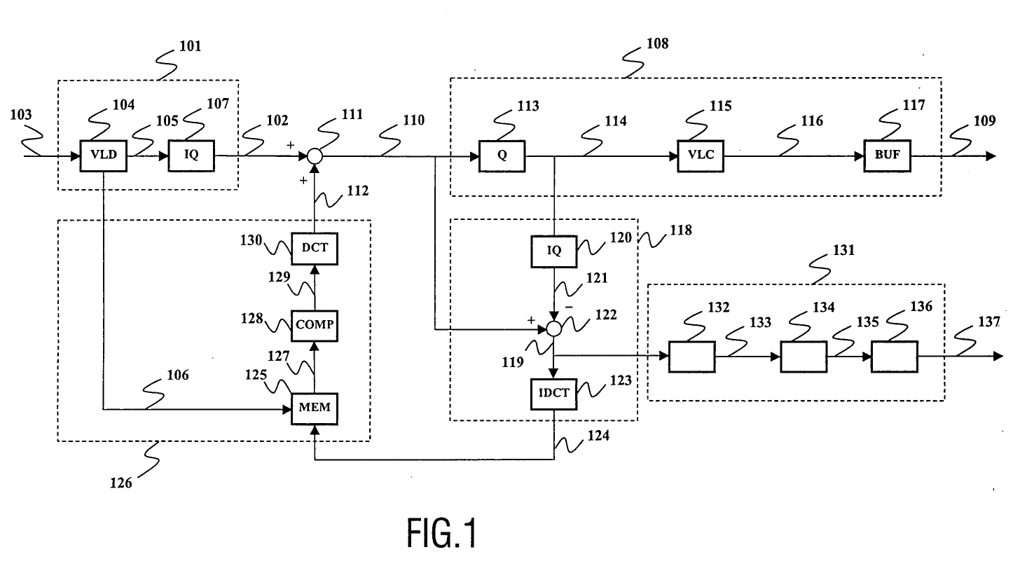

FIG. 1 depicts a first embodiment of the method according to the invention. This embodiment is based on a transcoding arrangement comprising at least an error decoding step 101 for generating a decoded data signal 102 from a current input coded video signal 103. This error decoding step 101 performs a partial decoding of the input video signal 103 since only a reduced number of data type comprised in said input signal are decoded. This step comprises a variable-length decoding (VLD) denoted by reference numeral 104 of at least DCT coefficients and motion vectors comprised in signal 103. This step consists of an entropy decoding (e.g. by means of an inverse look-up table comprising Huffinan codes) for obtaining decoded DCT coefficients 105 and motion vectors 106. In series with said step 104, an inverse quantization (IQ) denoted 107 is performed on said decoded coefficients 105 for generating said decoded data signal 102. The inverse quantization 107 mainly consists of multiplying said DCT decoded coefficients 105 by a quantization factor said input signal 103. In most cases, this inverse quantization 107 is performed at the macroblock level because said quantization factor may change from one macroblock to another. The decoded signal 102 comprises data in the frequential domain.

This transcoding arrangement also comprises a re-encoding step 108 for generating an output video signal 109 corresponding to the signal resulting from the transcoding of said input video signal 103. This video signal 109 is designated as the base video signal. Signal 109 is compliant with the MPEG-2 video standard as input signal 103. Said re-encoding 108 acts on an intermediate data signal 110 which results from the addition, by means of the adding sub-step 111, of said decoded data signal 102 to a modified motion-compensated signal 112. Said re-encoding step 108 comprises in series a quantization (Q) denoted 113. This quantization 113 consists of dividing DCT coefficients in signal 110 by a new quantization factor, for generating quantized DCT coefficients 114. Such a new quantization factor characterizes the modification performed by the transcoding of said input coded video signal 103, because, for example, a larger quantization factor than the one used in step 107 may result in a bitrate reduction of said input coded video signal 103. In series with said quantization 113, a variable-length coding (VLC) denoted 115 is applied on said coefficients 114 for obtaining entropy-coded DCT coefficients 116. Similarly to VLD processing, VLC processing consists of a look-up table for defining a Huffman code to each coefficient 114. Then, coefficients 116 are accumulated in a buffer (BUF) denote 117, as well as motion vectors 106 (not depicted), for constituting transcoded frames carried by said base video signal 109.

This arrangement also comprises a reconstruction step 118 for generating the coding error 119, in the frequential domain, of said base video signal 109. This reconstruction step allows quantifying of the coding error introduced by the quantization 113. Such a coding error of a current transcoded video frame is taken into account, during a motion compensation step hereinafter described in detail, for the transcoding of the next video frame for avoiding quality drift from frame to frame in the base video signal 109. Said coding error 119 is reconstructed by means of an inverse quantization (IQ) denoted to as 120 and performed on said signal 114, resulting in signal 121. A subtracting sub-step 122 is then performed between signals 110 and 121, resulting in said coding error 119 in the DCT domain, i.e. in the frequential domain. Such a coding error 119 corresponds to the difference between said input coded video signal 103 and said base video signal 109. Said coding error 119 in the frequential domain is passed through an inverse discrete cosine transform (IDCT) denoted to as 123 for generating the corresponding coding error 124 in the pixel domain.

This arrangement also comprises a motion compensation step 126 for generating said motion-compensated signal 112, from a coding error stored in memory (MEM) denoted 125 and relative to a previous transcoded video frame carried by signal 109. Memory 125 comprises at least two sub-memories: the first one dedicated to the storage of the modified coding error 124 relative to a video frame being transcoded, and the second one dedicated to the storage of the modified coding error 124 relative to a previous transcoded video frame. First, a motion compensation (COMP) denoted 128 is performed in a prediction step on the content of said second sub-memory accessible by signal 127. The prediction step consists of calculating a predicted signal 129 from said stored coding error 127: The predicted signal, also called motion-compensated signal, corresponds to the part of the signal stored in said memory device 125 that is pointed by the motion vector 106 relative to the part of the input video signal 102 being transcoded. As is known to those skilled in the art, said prediction is usually performed at the MB level, which means that for each input MB carried by signal 102, a predicted MB is determined and further added by adding sub-step 111 in the DCT domain to said input MB for attenuating quality drift from frame to frame. As the motion-compensated signal 129 is in the pixel domain, it is passed through a DCT step 130 for generating said motion-compensated signal 112 in the DCT domain.

This arrangement also comprises a re-encoding step 131 for generating an enhancement video signal 137 from said coding error 119. This re-encoding step is based on a bit-plane coding method that comprises a shifting sub-step 132 for shifting bit-planes, or preferably parts of bit-planes of data composing said coding error 119. Considering that input coded video signal 103 is coded in accordance with a block-based technique using 8*8 DCT blocks, as well as said coding error 119, a bit-plane consists advantageously of an array of 64 bits of the same rank extracted from the 64 data composing a 8*8 coding error block. For example, a first bit-plane will be composed of 64 bits corresponding to the first most significant bits (MSB) of said 64 data, a second bit-plane will be composed by 64 bits corresponding to the second MSB of said 64 data, etc . . . If a weighting method is used, the shift is performed at the MB level, i.e. all bits of data composing said MB are shifted by the same value to the left. For example, dealing with a 420 video format, four sets of 64 coefficients relative to the luminance data and two sets of chrominance data will be defined and thus shifted. Shifted bit-planes 133 are thus analyzed by the sub-step 134 consisting of finding the maximum value among data composing said shifted bit-planes. Said maximum valve is directly used for deriving the number of shifted bit-planes 133. For example, if after shifting by sub-step 132, shifted bit-planes 133 comprise the following set of 64 data (10, 0, 6, 0, 0, 3, 0, 2, 2, 0, 0, 2, 0, 0, 1, 0, . . . 0, 0), the maximum value in this block is found to be 10 and the minimum number of bits to represent 10 in the binary format (1010) is 4. Writing every value in the binary format using 4 bits, 4 bit-planes are formed as follows:

| | |
|---|---|
| (1, 0, 0, 0, 0, 0, 0, 0, 0, 0, 0, 0, 0, 0, 0, 0, . . . 0, 0) | (MSB-plane) |
| (0, 0, 1, 0, 0, 0, 0, 0, 0, 0, 0, 0, 0, 0, 0, 0, . . . 0, 0) | (Second MSB- |
| | plane) |
| (1, 0, 1, 0, 0, 1, 0, 1, 1, 0, 0, 1, 0, 0, 0, 0, . . . 0, 0) | (Third MSB-plane) |
| (0, 0, 0, 0, 0, 1, 0, 0, 0, 0, 0, 0, 0, 0, 1, 0, . . . 0, 0) | (Fourth MSB- |
| | plane = LSB-plane) |

In a subsequent sub-step, shifted bit-planes are coded by a variable-length coding sub-step 136 for generating variable length coded data composing said enhancement video signals 137. To this end, bit-planes can be first converted into 2-D symbols (RUN, EOP) as follows:

number of consecutive 0's before a 1 (RUN),

whether there are any 1's left on this bit-plane, i.e. End-Of-Plane (EOP). If a bit-plane after the MSB plane comprises all 0's, a special symbol ALL-ZERO is formed to represent an all-zero bit-plane.

Converting the bits of the four bit-planes into (RUN, EOP) symbols, we have:

| | |
|---|---|
| (0, 1) | (MSB-plane) |
| (2, 1) | (Second MSB-plane) |
| (0, 0), (1, 0), (2, 0), (1, 0), (0, 0), | (Third MSB-plane) |
| (2, 1) | |
| (5, 0), (8, 1) | (Fourth MSB-plane = LSB-plane) |

Each 2-D symbol is thus VLC coded by means of a look-up table associating a VLC code with each 2-D symbol.

Said signals 137 can be seen as a single enhancement video signal if all bit-planes are transmitted simultaneously as one signal with said base video signal. Said signal 137 itself can also be seen as a scalable video signal to be transmitted simultaneously with said base video signal if a reduced number of bit-planes is omitted before or during transmission, such as the least significant bit-planes (LSB-planes). The number of enhancement video signals 137 may be increased by increasing the shifting to the left, said shifting being preferably performed on data of high importance in order not to loose the corresponding information when LSB-planes are omitted. As a consequence, if the number of bit-planes is increased, the scalability of signal 137 has a finer granularity, which allows a target bitrate to be reached more precisely, said target bitrate being the sum of the base video signal bitrate with the bitrate of the selected set of bit-planes in signal 137.

The shift applied to data composing signal 119 can be performed at the frame level thanks to a 8*8 weighting matrix comprising shift values stored in a picture header. Each value composing a 8*8 block data is then shifted in accordance with the shift value having the same row and column in said weighting matrix. In this way, frequential areas within a 8*8 block can be advantageously more shifted than other frequential areas if they are considered to comprise more important coefficients.

The shift may also consist of a selective shifting of partial areas within a given frame carried by signal 119. To this end, a shift which value is contained in MB headers is performed on all data composing MB defining said partial region. This shifting method is advantageously used when said partial area is a region of interest in the video sequence that must be preserved.

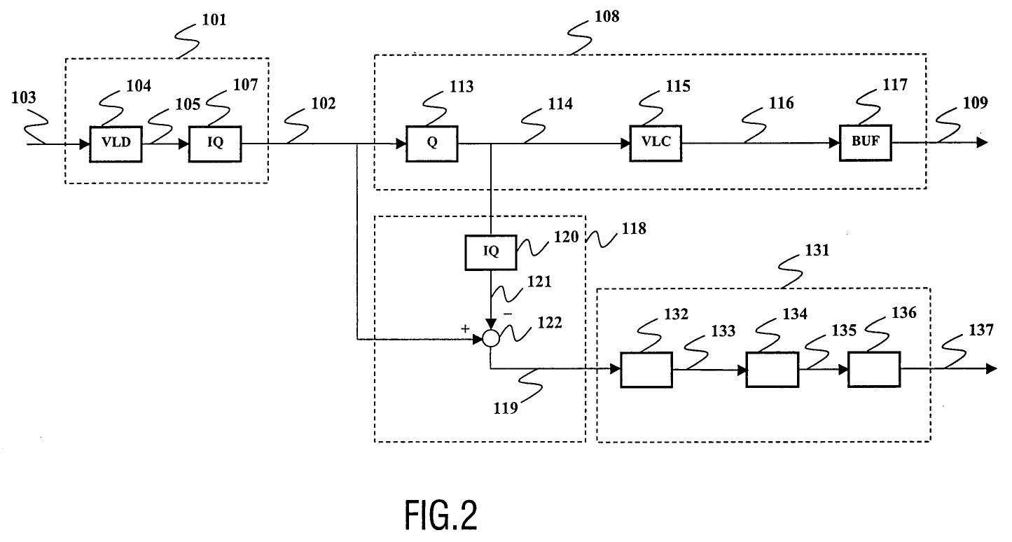

FIG. 2 depicts a second embodiment of the method according to the invention. This embodiment is based on the FIG. 1 in which the coding loop including the motion compensation step has been opened. This allows a reduction of the computational load of the method according to the invention, to the detriment of the video quality because a drift appears from frame to frame in the base video signal 109. Indeed, this transcoding method leads to a drifty base video signal 109 since the coding error 119 caused by the quantization step 113 is no more reintroduced in the transcoding of the next frames.

The advantage of this method is to separately re-encode the coding error 119 by the re-encoding step 131, resulting in the generation of one or a plurality of enhancement video signals 137. Thus, the recombination of the base video signal with the enhancement video signals allows to form a video signal of better quality compared to the video quality of the base video signal.

The scalability of signal 137 prevents said quality drift because the coding error 119 can thus be partially or totally transmitted simultaneously with said base video signal.

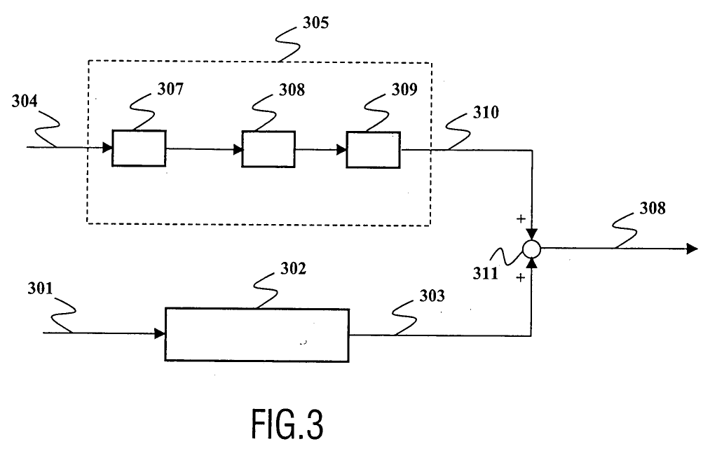

FIG. 3 depicts the decoding principle of a video signal generated by the method according to the invention, which is not part of the invention as it is described in the document INTERNATIONAL ORGANISATION FOR STANDARDISATION ISO/IEC JTC1/SC29/WG11 CODING OF MOVING PICTURES AND AUDIO, ISO/IEC JTC1/SC29/WG11, N3317, March 2000, FGS Verification Model. This decoding consists of separately decoding the base video signal and enhancement video signals. The base video signal 301 is decoded by a standard decoder 302 according to the MPEG-2 video standard that generates the decoded base video signal 303, while bit-planes of enhancement video signals 304 are decoded by a hybrid decoder 305. If enhancement video signals have been generated by the embodiment shown in FIG. 1 or FIG. 2, said hybrid decoding 305 consists of sequential sub-steps comprising a variable-length decoding sub-step 307, a sub-step 308 for shifting back variable-length decoded bit-planes to the right, an inverse discrete cosine transform 309 generating pixel-based enhancement video signals 310. Thus, by means of adding sub-step 311, signals 303 and 310 are added, so as to result in the decoded enhanced video signal 308.

This method of modifying data according to the invention can be implemented in a transcoding device in different contexts.

Such a transcoding device may correspond to video broadcast or video streaming equipment. In this context, an input video signal coded in accordance with the MPEG-2 video standard can be sent after processing through communication channels having different bandwidth capacities by associating a variable number of enhancement video signals (i.e. a more or less important number of bit-planes) with the base video signal.

Such a transcoding device may also correspond to consumer products such as a set-top box or a Digital Video Disc (DVD). In this context, after processing of an input video signal coded in accordance with the MPEG-2 video standard, the base video signal and its associated enhancement video signals are locally stored in memory means. Then, in the case of a lack of memory space, one or a plurality of enhancement video signals can be removed from said memory means without suppressing the totality of the video sequence. This device is particularly dedicated to elastic storage application.

This method of modifying data in an input coded video signal can be implemented in several manners in a video transcoding device. First in using hardware components, this scalable method can be implemented by means of wired electronic circuits (e.g. shift registers for performing shifting sub-steps, RAM memories for storing video frames during the motion compensation step and data buffering), or secondly in using software components by means of a set of instructions stored in a computer-readable medium, said instructions replacing at least a portion of said circuits and being executable under the control of a computer or a digital processor in order to carry out the same functions as fulfilled in said replaced circuits.

The invention therefore also relates to a computer-readable medium comprising a software module which includes computer executable instructions for performing the steps, or some steps, of the first and second method described above.

1. A method of modifying data in an input coded video signal, for generating an output scalable video signal composed of a base video signal and a set of at least one enhancement video signal, said method comprising at least:
an error decoding step for generating a decoded data signal from said input coded video signal,
a first re-encoding step for generating said base video signal from an intermediate data signal resulting from the addition of a motion compensated signal with said decoded data signal,
a reconstruction step for generating a coding error of said base video signal,
a motion compensation step for generating said motion compensated signal from said coding error,
characterized in that said method comprises a second re-encoding step for generating said enhancement video signal from said coding error.

2. A method of modifying data in an input coded video signal, for generating an output scalable video signal composed of a base video signal and a set of at least one enhancement video signal, said method comprising at least:
an error decoding step for generating a decoded data signal from said input coded video signal,
a first re-encoding step for generating said base video signal from said decoded data signal,
a reconstruction step for generating a coding error of said base video signal,
characterized in that said method comprises a second re-encoding step for generating said enhancement video signal from said coding error.

3. A method of modifying data as claimed in claim 1, characterized in that said second re-encoding step comprises:
a shifting sub-step for shifting bit-planes of data composing said coding error,
a sub-step for finding the maximum value among data composing said shifted bit-planes, and deriving the number of shifted bit-planes to be re-encoded,
a variable-length coding sub-step of said shifted bit-planes for generating variable-length coded bit-planes, each variable length coded bit-plane defining an enhancement video signal.

4. A transcoding device for modifying data in an input coded video signal, for generating an output scalable video signal composed of a base video signal and a set of at least one enhancement video signal, said transcoding device comprising at least:
error decoding means for generating a decoded data signal from said input coded video signal,
first re-encoding means for generating said base video signal from an intermediate data signal resulting from the addition of a motion-compensated signal with said decoded data signal,
reconstruction means for generating a coding error of said base video signal,
motion compensation means for generating said motion-compensated signal from said coding error,
characterized in that said transcoding device comprises second re-encoding means for generating said enhancement video signal from said coding error.

5. A transcoding device for modifying data in an input coded video signal, for generating an output scalable video signal composed of a base video signal and a set of at least one enhancement video signal, said transcoding device comprising at least:
error decoding means for generating a decoded data signal from said input coded video signal,
first re-encoding means for generating said base video signal from said decoded data signal,
reconstruction means for generating a coding error of said base video signal,
characterized in that said transcoding device comprises second re-encoding means for generating said enhancement video signal from said coding error.

6. A transcoding device as claimed in claim 4 characterized in that said second re-encoding means comprises:
shifting means for shifting bit-planes of data composing said coding error,
means for finding the maximum value among data composing said shifted bit-planes, and deriving the number of shifted bit-planes to be re-encoded,
variable-length coding means of said shifted bit-planes for generating variable-length coded bit-planes, each variable-length coded bit-plane defining an enhancement video signal.

7. A set-top box product for receiving an input coded video signal, said set-top box product comprising a transcoding device as claimed in claim 4 for modifying data in said input coded video signal, for generating an output scalable video signal composed of a base video signal and a set of at least one enhancement video signal.

8. A coded video signal comprising a base video signal and a set of at least one enhancement video signal, said coded video signal resulting from an implementation of a method of modifying data in an input coded video signal as claimed in claim 1.

9. A storage medium having stored thereon a coded video signal, said coded video signal comprising a base layer and a set of enhancement layers, said coded video signal resulting from an implementation of a method of modifying data in an input coded video signal as claimed in claim 1.

10. A computer program comprising code instructions for implementing the steps and sub-steps of one of the methods as claimed in claim 1.
